(19) United States
(12) Patent Application Publication
(10) Pub. No.: US 2017/0262895 A1
(43) Pub. Date: Sep. 14, 2017

(54) SEARCH APPARATUS, SEARCH METHOD, AND SEARCH PROGRAM

(71) Applicant: YAHOO JAPAN CORPORATION, Tokyo (JP)

(72) Inventors: Kensho HIRASAWA, Tokyo (JP); Tatsuya UCHIYAMA, Tokyo (JP); Hiroki NARUKAWA, Tokyo (JP)

(73) Assignee: YAHOO JAPAN CORPORATION, Tokyo (JP)

(21) Appl. No.: 15/380,802

(22) Filed: Dec. 15, 2016

(30) Foreign Application Priority Data
Mar. 9, 2016 (JP) 2016-046216

(51) Int. Cl. G06Q 30/02; G06F 17/30

(52) U.S. Cl. CPC G06Q 30/0269; G06F 17/30011; G06F 17/30522

(57) ABSTRACT

An advertising apparatus receives requirements for searching documents, acquires, for each of the requirements, a first list that arranges in ascending order document numbers, each of which is associated with a corresponding one of the documents and extracts starting document numbers of the respective requirements of the first list to thereby prepare a second list. Each starting document number totals a count that satisfies a minimum requirement count that represents the number of requirements required for the document to be searched. When a maximum document number among the document numbers belonging to the second list matches another document number, the advertising apparatus retains the other document number in the second list, and when another document number does not match the maximum document number, the advertising apparatus replaces the other document number with any other document number in the first list to which the other document number belongs.

### CROSS-REFERENCE TO RELATED APPLICATION(S)

The present application claims priority to and incorporates by reference the entire contents of Japanese Patent Application No. 2016-046216 filed in Japan on Mar. 9, 2016.

### BACKGROUND OF THE INVENTION

1. Field of the Invention

The present invention relates to a search apparatus, a search method, and a search program.

2. Description of the Related Art

Advertisement delivery using information acquired via a network is actively performed in accordance with the recent significant spread of the Internet. In such advertisement delivery, in order to enhance advertisement effect, targeting delivery is performed in which an advertiser registers in advance user information such as tastes, sexes, ages, addresses, and occupations of users and selectively delivers an advertisement corresponding to the user information. In such targeting delivery, the advertiser often sets a Boolean expression for selecting a target user for the targeting delivery on an advertisement content side on the basis of a user attribute the advertiser desires.

For a query received as user information, a data structure such as an inverted index is utilized as a technique for quickly searching a group of advertisement content items for which Boolean expressions have been set for a specific advertisement content item for which a Boolean expression that matches the query is set. The inverted index refers to a data structure for extracting a document using keywords (terms) included in the Boolean expression set for the document. Techniques that quickly searches documents by determining whether, using the inverted index, a query satisfies a requirement for matching a document as a search object are disclosed (see, for example, Steven Euijong Whang, Hector GarciaMolina, Chad Brower, Jayavel Shanmugasundaram, Sergei Vassilvitskii, Erik Vee, Ramana Yerneni, “Indexing Boolean Expressions” [online], [retrieved on Feb. 16, 2016], the Internet (http://theory.stanford.edu/˜sergei/papers/vldb09-indexing.pdf), and Marcus Fontoura, Suhas Sadanandan, Jayavel Shanmugasundaram, Sergei Vassilvitski, Erik Vee, Srihari Venkatesan, Jason Zien, “Efficiently Evaluating Complex Boolean Expressions” [online], [retrieved on Feb. 16, 2016], the Internet (http://theory.stanford.edu/—sergei/papers/sigmod10-index.pdf).

The known techniques mentioned above, however, encounter difficulty in improving search efficiency during a document search operation using the inverted index. Specifically, the known techniques yield poor search efficiency due to useless search of documents not satisfying the requirement for a match, continuously performed during the search of the documents of the inverted index.

### SUMMARY OF THE INVENTION

It is an object of the present invention to at least partially solve the problems in the conventional technology.

A search apparatus according to the present application includes a reception unit that receives requirements for searching documents, an acquisition part that acquires, for each of the requirements, a first list including the requirement, the first list arranging document numbers in ascending order, the document numbers being assigned to and associated with respective documents, and a search unit that extracts starting document numbers of the respective requirements of the first list acquired by the acquisition part to prepare a second list, the starting document numbers each totaling a count that satisfies a minimum requirement count that represents at least a minimum number of requirements required as a condition for the document to be searched, that retains, when a maximum document number among the document numbers belonging to the second list matches another document number included in the second list, the other document number in the second list, and that replaces, when another document number does not match the maximum document number, the other document number with any other document number in the first list to which the other document number belongs, to search for a predetermined document number such that the count of the predetermined document number in the second list satisfies the minimum requirement count. The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram for illustrating exemplary minimum requirement counts according to an embodiment;

FIG. 2 is a diagram for illustrating an exemplary inverted index and an exemplary postings list according to the embodiment;

FIG. 3 is a diagram for illustrating exemplary known art;

FIG. 4 is a diagram for illustrating an exemplary search process according to the embodiment;

FIG. 5 is a diagram illustrating an exemplary configuration of a search process system according to the embodiment;

FIG. 6 is a diagram illustrating an exemplary configuration of an advertising apparatus according to the embodiment;

FIG. 7 is a diagram illustrating an exemplary advertising information storage unit according to the embodiment;

FIG. 8 is a diagram illustrating an exemplary user information storage unit according to the embodiment;

FIG. 9 is a flowchart illustrating a search process performed by the advertising apparatus according to the embodiment;

FIG. 10 is a flowchart illustrating a process for searching for advertisement content items as delivery candidates;

FIG. 11 is a flowchart illustrating a process for initializing a prioritized queue;

FIG. 12 is a flowchart illustrating a process for selecting a document number as a match candidate; and

FIG. 13 is a hardware configuration diagram illustrating an exemplary computer that achieves functions of the advertising apparatus.

### DETAILED DESCRIPTION OF THE PREFERRED EMBODIMENTS

The following details, with reference to the accompanying drawings, modes (hereinafter referred to as “embodiments”) for carrying out a search apparatus, a search method, and a search program according to the present application. It is to be understood that the embodiments do not intend to limit the search apparatus, the search method, and the search program according to the present application. Each of the embodiments may be combined with each other as appropriate within a range in which processing details are not contradictory to each other. In each of the following embodiments, like or similar elements are identified by like reference numerals and descriptions for those elements will not be duplicated.

1. Exemplary Search Process

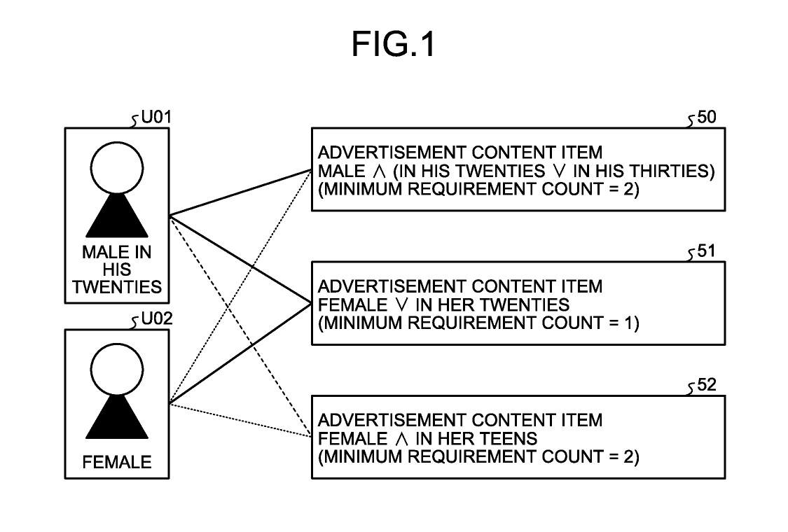

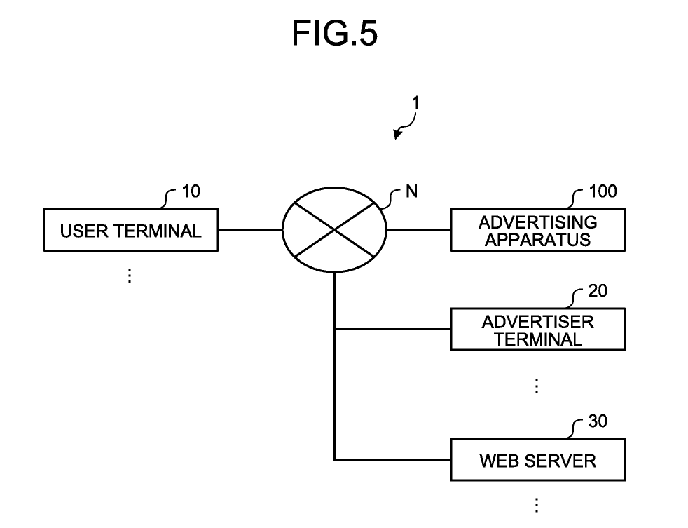

An advertising apparatus 100 (see FIG. 5) corresponding to the search apparatus according to the present application is a server device that, using a query transmitted from a user terminal 10 (see FIG. 5), searches a group of documents for which Boolean expressions have been set for a specific document for which a Boolean expression that matches the query is set. It is noted that the query is inquiry information used for document search. In the example illustrated in FIG. 1, a document is an advertisement content item. The Boolean expression set for the advertisement content item is set by an advertiser for selecting a user as a delivery object. In the embodiments, the query includes, for example, information on a user who operates the user terminal 10 as a query transmission source and information on an advertisement page (e.g., web page) on which an advertisement content item is displayed.

The following describes, with reference to FIG. 1, a minimum requirement count according to the embodiments. FIG. 1 is a diagram for illustrating exemplary minimum requirement counts according to the embodiments. The minimum requirement count represents a minimum number of requirements required for a query to match a document. In the example illustrated in FIG. 1, the minimum requirement count is a minimum number of pieces of attribute information that need to be included in the query in order for the query to match the Boolean expression set for the document. In addition, the query transmitted from the user terminal 10 includes attributes (e.g., sexes and age brackets) of the user who operates the user terminal 10. It should be noted that, in the following, the expression that “the query matches a Boolean expression set for the document” may be expressed simply as “the query matches the document”.

As illustrated in FIG. 1, Boolean expressions for selecting a user as the delivery object are set for advertisement content items 50, 51, and 52 as search objects. The Boolean expression set for each of the advertisement content items 50, 51, and 52 is formed of a combination of user attribute information and Boolean operators. Specifically, Boolean expressions of “male [symbol] (in their twenties [symbol] in their thirties)”, “female [symbol] in their twenties”, and “female [symbol] in their teens” are set for the advertisement content item 50, the advertisement content item 51, and the advertisement content item 52, respectively, where “ [symbol] ” and “ [symbol] ” denote Boolean operators of “AND” and “OR”, respectively.

For example, the Boolean expression set for the advertisement content item 50 indicates that, in order for the query to match the advertisement content item 50, at least two pieces of attribute information of “sex (male)” and “age bracket (in their twenties [symbol] in their thirties)” are required. Specifically, the minimum requirement count set for the advertisement content item 50 is “2”. The Boolean expression set for the advertisement content item 51 indicates that, in order for the query to match the advertisement content item 51, at least one piece of attribute information of “sex (female)” or “age bracket (in their twenties)” is required. Specifically, the minimum requirement count set for the advertisement content item 51 is “1”. The Boolean expression set for the advertisement content item 52 indicates that, in order for the query to match the advertisement content item 52, at least two pieces of attribute information of “sex (female)” or “age bracket (in their teens)” are required. Specifically, the minimum requirement count set for the advertisement content item 52 is “2”.

In the example illustrated in FIG. 1, a user U01 is to transmit a query that includes two pieces of attribute information of “in their twenties” and “male” to the side of an apparatus that searches for the advertisement content. The minimum requirement counts set for the advertisement content item 50, the advertisement content item 51, and the advertisement content item 52 are “2”, “1”, and “2”, respectively, as described above. The number of pieces of attribute information included in the query transmitted from the user U01 is “2”. Thus, the query transmitted from the user U01 satisfies the condition of the minimum requirement counts set for the advertisement content item 50, the advertisement content item 51, and the advertisement content item 52. Hence, the query transmitted from the user U01 is likely to match all of the advertisement content item 50, the advertisement content item 51, and the advertisement content item 52.

The advertising apparatus 100 accurately evaluates the Boolean expressions for the advertisement content items 50, 51, and 52 which the query is likely to match. The Boolean expression set for the advertisement content item 50 is “male [symbol] (in their twenties [symbol] in their thirties)”. Of the information contained in the query transmitted from the user U01, “male” satisfies “male” of the Boolean expression set for the advertisement content item 50. Additionally, of the information contained in the query transmitted from the user U01, “in their twenties” satisfies “(in their twenties [symbol] in their thirties)” of the Boolean expression set for the advertisement content item 50. Thus, the query transmitted from the user U01 matches the advertisement content item 50.

The Boolean expression set for the advertisement content item 51 is “female [symbol] (in their twenties)”. Of the information contained in the query transmitted from the user U01, “in their twenties” satisfies “female [symbol] (in their twenties)” of the Boolean expression set for the advertisement content item 51. Thus, the query transmitted from the user U01 matches the advertisement content item 51.

Meanwhile, the Boolean expression set for the advertisement content item 52 is “female [symbol] (in their teens)”. Of the information contained in the query transmitted from the user U01, “in their twenties” does not satisfy “in their teens” of the Boolean expression set for the advertisement content item 52. Additionally, of the information contained in the query transmitted from the user U01, “male” does not satisfy female” of the Boolean expression set for the advertisement content item 52. Thus, the query transmitted from the user U01 does not match the advertisement content item 52.

The following describes the example of the user U02. In the example illustrated in FIG. 1, the user U02 is to transmit a query that includes one piece of attribute information of “female” to the side of the apparatus that searches for the advertisement content. The minimum requirement counts set for the advertisement content item 50, the advertisement content item 51, and the advertisement content item 52 are “2”, “1”, and “2”, respectively, as described above. The number of pieces of attribute information included in the query transmitted from the user U02 is “1”. Thus, the query transmitted from the user U02 satisfies the condition of the minimum requirement counts set for the advertisement content item 51. Hence, the query transmitted from the user U02 is likely to match the advertisement content item 51.

Meanwhile, the number of pieces of attribute information contained in the query transmitted from the user U02 is “1”. Thus, the query transmitted from the user U02 does not satisfy the condition of the minimum requirement count set for the advertisement content item 50 or the advertisement content item 52. Hence, the query transmitted from the user U02 is not likely to match the advertisement content item 50 or the advertisement content item 52.

For the advertisement content item 51 which the query is likely to match, the Boolean expression is accurately evaluated. The Boolean expression set for the advertisement content item 51 is “female [symbol] (in their twenties)”. Of the information contained in the query transmitted from the user U02, “female” satisfies “female” of the Boolean expression set for the advertisement content item 51. Thus, the query transmitted from the user U02 matches the advertisement content item 51.

As such, the search technique using the Boolean expression can detect an advertisement content item that is not likely to match the query on the basis of the minimum requirement count without the need to accurately evaluate the Boolean expression.

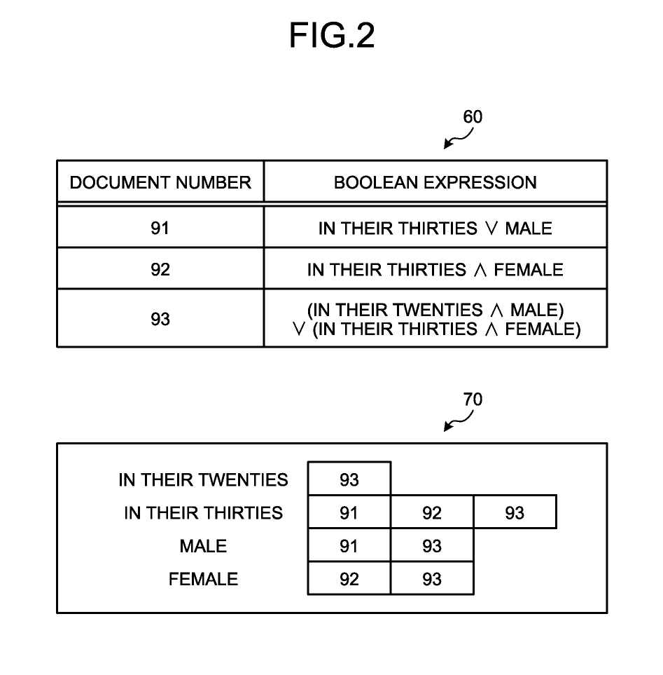

The following describes, with reference to FIG. 2, an inverted index and a postings list according to the embodiments. FIG. 2 is a diagram for illustrating an exemplary inverted index and an exemplary postings list according to the embodiments.

The advertising apparatus 100 according to the embodiments uses a document number as an identification number that identifies a document. The document number is assigned in advance to the document such that the minimum requirement count increases with an increasing document number.

As illustrated in FIG. 2, a list 60 sets a Boolean expression for each document associated with a specific document number. Specifically, Boolean expressions of “in their thirties [symbol] male”, “in their thirties [symbol] female”, and “(in their twenties [symbol] male) [symbol] (in their thirties [symbol] female)” are set for the documents associated with document number 91, document number 92, and document number 93. It is noted that, in the following, the expression of “the minimum requirement count set for a document associated with a document number” may be expressed simply as “the minimum requirement count set for a document number”.

The inverted index is a data structure that associates keywords (terms) included in a document with the document. In the example illustrated in FIG. 2, the inverted index is a data structure for finding a document from the attribute information included in the Boolean expression set for that particular document. In the example illustrated in FIG. 2, the inverted index for the list 60 is an inverted index 70. As illustrated in FIG. 2, the inverted index 70 stores the document number for each piece of attribute information included in the Boolean expressions in the list 60.

The inverted index represents a collection of postings lists indicating the Boolean expression set for a document, in which a specific piece of attribute information included in the Boolean expression set for the document is included. In the example illustrated in FIG. 2, the postings list is a list of document numbers corresponding to a specific piece of attribute information of the inverted index 70. For example, in the example of FIG. 2, the postings list of “in their thirties” is “91”, “92”, and “93”. It is noted that the document numbers in ascending order are arrayed as elements of the postings list.

1-1. Search Process in Known Art

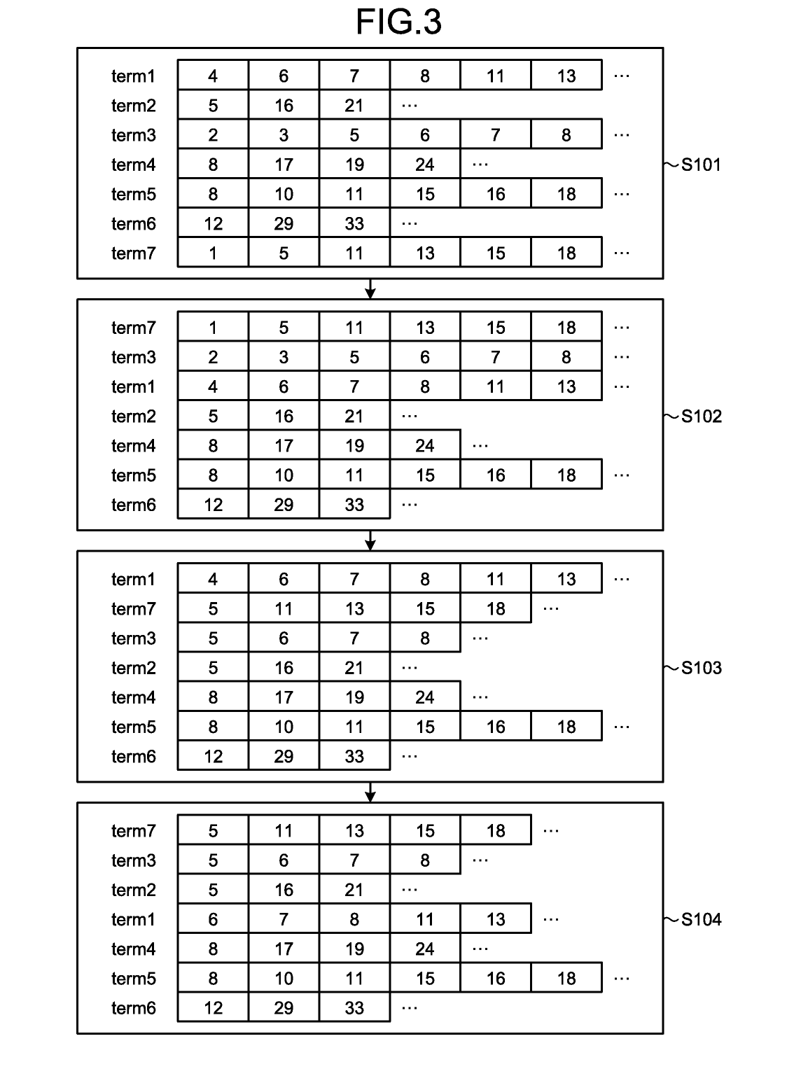

The following describes, with reference to FIG. 3, known art that searches documents for which Boolean expressions are set. FIG. 3 is a diagram for illustrating exemplary known art. A search technique according to the known art (hereinafter referred to as a “known technique”), having received a query, first refers to a postings list that is associated with keywords included in the query using a predetermined inverted index that includes documents as the search objects (Step S101). Then, as illustrated in the example of FIG. 1, the known technique extracts document numbers associated with documents that are likely to match the query on the basis of the minimum requirement counts of the document numbers.

For convenience sake, all of the minimum requirement counts set for the documents as the search objects is assumed to be “3” and the keywords included in the received query are denoted as term 1 through term 7. Furthermore, the predetermined inverted index that includes the documents as the search objects is assumed to include postings lists of term 1 through term 7. Each of the postings lists of term 1 to term 7 includes document numbers associated with each keyword as illustrated in FIG. 3. It is noted that, as illustrated in the example of FIG. 2, the elements of each of the postings lists represent the document numbers arranged in ascending order.

When a count of a document number stored in different postings lists satisfies the condition of the minimum requirement count set for that particular document number, the document associated with that particular document number is likely to match the query. For example, as illustrated in FIG. 3, document number 5 is stored in respective postings lists of term 2, term 3, and term 7 (Step S101). Specifically, it is indicated that the keywords of term 1, term 3, and term 7 are included in the Boolean expression set for document number 5. It is here noted that the minimum requirement count set for document number 5 is 3, so that the query including the three keywords of term 1, term 3, and term 7 is likely to match the document associated with document number 5. In the following, the expression that “the query matches the document associated with the document number” may be expressed simply that “the query matches the document number”.

The known technique next sorts the postings lists such that document numbers of starting elements in the respective postings lists are in ascending order as viewed from the start of the collection of postings lists (Step S102). Specifically, as illustrated in FIG. 3, the known technique sorts the postings lists of term 1 through term 7 so that the postings list of term 7 including the starting element having the smallest document number is uppermost.

In the example of FIG. 3, document number 1 is included only as the starting element of the postings list of term 7. Thus, the count of document number 1 does not satisfy the minimum requirement count (3 in the present example) set for document number “1”. Specifically, document number 1 is not likely to match the query.

Additionally, as illustrated in FIG. 3, document number 2 is included as the starting element of the postings list of term 3. It is here noted that the starting element of the postings list of term 7 is document number 1. Thus, the postings list of term 7 is likely to include document number 2 as an element following the starting element. Even when document number 2 is included as an element following the starting element in the postings list of term 7, however, at most two document number 2's are available. Thus, the count of document number 2 does not satisfy the minimum requirement count set for document number 2. Specifically, document number 2 is not likely to match the query.

Additionally, as illustrated in FIG. 3, document number 4 is included as the starting element of the postings list of term 1. It is here noted that the starting elements of the postings lists of term 7 and term 3 are document number 1 and document number 2, respectively. Thus, the postings lists of term 7 and term 3 each are likely to include document number 4 as an element following the starting element. When document number 4 is included as an element following the starting element in each of the postings lists of term 7 and term 3, the count of document number 4 satisfies the minimum requirement count set for document number 4. Specifically, document number 4 is a document number as a match candidate.

In the postings list that is likely to include a document number as a match candidate following the starting element, the known technique advances the document number to be referred to until the starting element of the postings list is a document number equal to or greater than the document number as the match candidate (Step S103). Specifically, in each of the postings lists of term 7 and term 3, the known technique advances the document number to be referred to until the starting element of the postings list is a document number equal to or greater than 4. After having advanced the document number to be referred to, the known technique sorts the postings lists such that the document numbers of the starting elements in the respective postings lists are in ascending order as viewed from the start of the collection of postings lists.

As a result of the advancement of the document numbers to be referred to, document number 4 is included only as the starting element of the postings list of term 1. Thus, the count of document number 4 does not satisfy the minimum requirement count set for document number 4. Specifically, document number 4 is not likely to match the query.

The known technique then, in a postings list that stores a document number that fails as a match candidate, advances the document number to be referred to up to a document number immediately following the document number that fails as a match candidate (Step S104). Specifically, in the postings list of term 1, the known technique advances the document number to be referred to such that the starting element of the postings list is a number following 4. After having advanced the document number to be referred to, the known technique sorts the postings lists such that the document numbers of the starting elements in the respective postings lists are in ascending order as viewed from the start of the collection of postings lists.

As a result of the advancement of the document numbers to be referred to, document number 5 is included as the starting elements of the postings lists of term 2, term 3, and term 7. Thus, the count of document number 5 satisfies the minimum requirement count set for document number 5. Specifically, document number 5 is likely to match the query. When the count of the document number as a match candidate satisfies the minimum requirement count set the document number as the match candidate, the known technique accurately evaluates the Boolean expression set for the document associated with the document number as the match candidate to thereby determine whether the query actually matches the document.

As mentioned previously, for each of all postings lists that are likely to include a document number as a match candidate, the known technique advances the document number to be referred to until the starting element of the postings list is a document number equal to or greater than the document number as the match candidate, as at Step S103. Specifically, at Step S103, the document number as the match candidate is 4. The postings lists in which the document number to be referred to is advanced are the postings lists of term 7 and term 3.

Consider a case, for example, in which the process for advancing the document number to be referred to is performed in order of the postings list of term 7 and the postings list of term 3. In this case, the count of document number 4 is determined not to satisfy the minimum requirement count set for document number 4 at the timing at which document number 4 is found not to be included in the postings list of term 7.

Specifically, the process is wasteful for advancing the document number to be referred to in the postings list of term 3 until the starting element of the postings list is 4 or greater after document number 4 has been determined not to match the query. As such, the known technique may wastefully perform the process for advancing the document number to be referred to after it has been determined that the count of a document number as a match candidate does not satisfy the minimum requirement count set for the document number as a match candidate. Specifically, the known technique unfortunately offers poor search efficiency.

1-2. Search Process by Search Apparatus According to Present Application

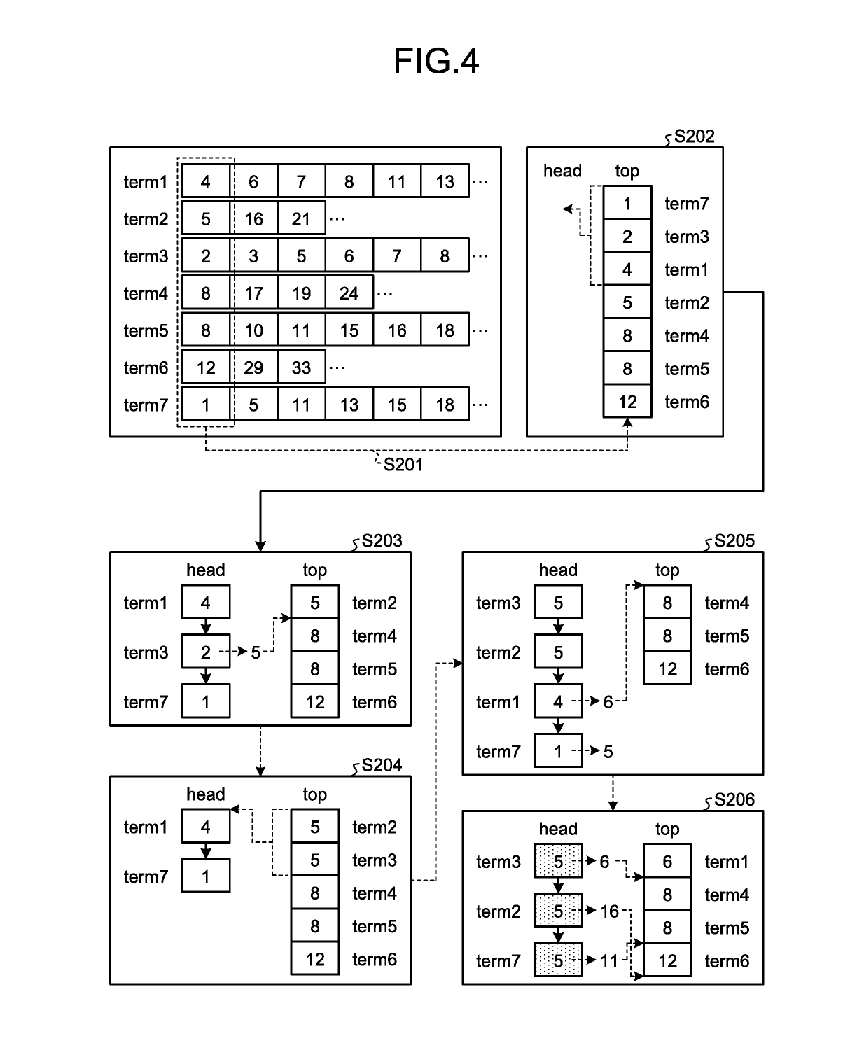

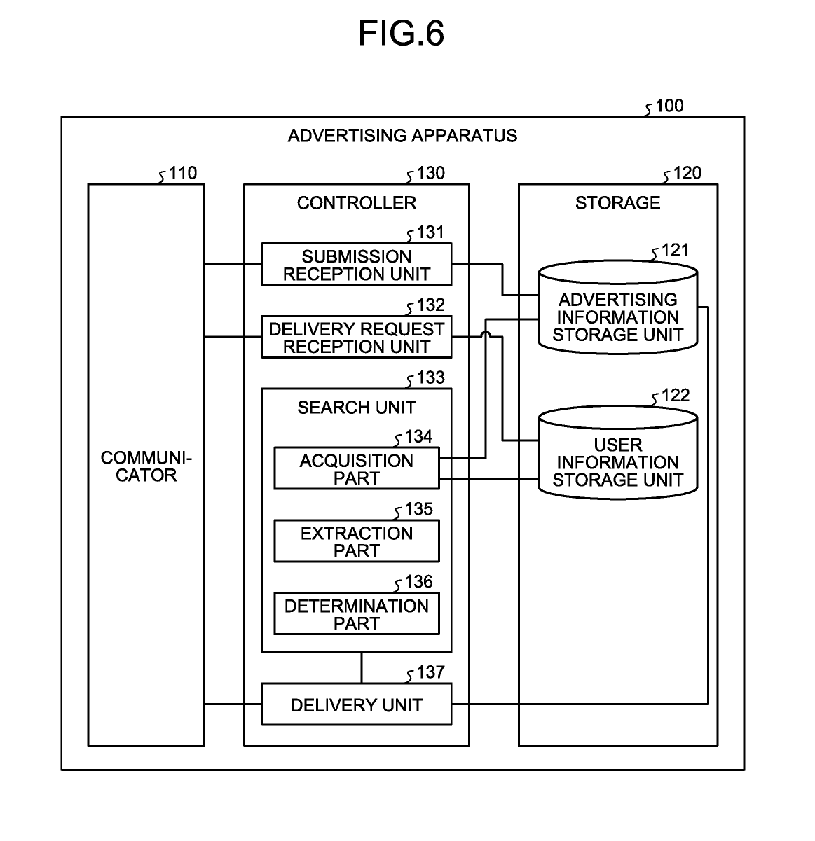

The following describes, with reference to FIG. 4, an exemplary search process performed by the advertising apparatus 100 that corresponds to the search apparatus according to the present application. FIG. 4 is a diagram for illustrating the exemplary search process according to the embodiments. The advertising apparatus 100 in the embodiments, having received a query, first refers to a postings list that is associated with keywords included in the query using an inverted index that includes documents as search objects. The inverted index that includes the documents as the search objects is stored, for example, in an advertising information storage unit 121 (see FIG. 6). As in the example illustrated in FIG. 1, the advertising apparatus 100 extracts document numbers associated with the documents that are likely to match the query on the basis of the minimum requirement counts set for the document numbers.

For the description of the advertising apparatus 100 in comparison with the known art, all of the minimum requirement counts set for the documents as the search objects is assumed to be “3” and the keywords included in the received query are denoted as term 1 through term 7, as in the example of FIG. 3. Furthermore, the inverted index that includes the documents as the search objects is assumed to include postings lists of term 1 through term 7. Each of the postings lists of term 1 to term 7 includes document numbers associated with each keyword as illustrated in FIG. 4. It is noted that, as illustrated in the example of FIG. 2, the elements of each of the postings lists represent the document numbers arranged in ascending order.

It should be noted that the search process performed by the advertising apparatus 100 described hereunder is applicable to a case in which the minimum requirement count set for the document number varies from one document number to another. In the example illustrated in FIG. 4, all of the minimum requirement counts set for the document numbers is “3” regardless of the document number. Thus, in the following description, the minimum requirement count remains constant irrespective of the document number. In general, however, the minimum requirement counts set for the documents may differ from one document number to another. The search process performed by the advertising apparatus 100 described hereunder is applicable also to a case in which the minimum requirement count set for the document number varies from one document number to another.

Reference is made to FIG. 4. Instead of sorting a collection of postings lists as in the known art, the advertising apparatus 100 utilizes two data structures of a linked list and a prioritized queue. The linked list is a data structure that places “head” at the upper portion of the list as illustrated in FIG. 4. The prioritized queue is a data structure that places “top” at the upper portion of the list. It is here noted that document numbers associated with respective postings lists are stored as elements of the linked list and of the prioritized queue.

The advertising apparatus 100 stores document numbers as the elements of the linked list in descending order of the document numbers as viewed from the starting element of the linked list. In addition, the advertising apparatus 100 temporarily stores document numbers in the prioritized queue. The advertising apparatus 100 is to move documents from the elements of the prioritized queue to the elements of the linked list in ascending order of document numbers. For convenience sake, FIG. 4 illustrates an example in which the elements of the prioritized queue are organized in accordance with the arrangement of the document numbers. A specific configuration of the elements of the prioritized queue is, however, not limited to the example of FIG. 4. It is noted that, when the advertising apparatus 100 stores the document numbers in the linked list and the prioritized queue, referencing is to be enabled to determine correspondence between stored document numbers and respective postings lists associated therewith.

The advertising apparatus 100 next refers to the starting document numbers in all postings lists of term 1 through term 7 illustrated in FIG. 4 and stores all of the starting document numbers to which the advertising apparatus 100 has referred in the prioritized queue (Step S201).

Then, the advertising apparatus 100 moves document numbers from the elements of the prioritized queue to the elements of the linked list until the number of elements in the linked list is the minimum requirement count set for the document number stored in the starting element of the linked list (Step S202). It is here noted that the document number as a candidate for matching the query is the starting document number in the linked list. Specifically, “4” that is the starting document number in the linked list is the document number as a match candidate.

The advertising apparatus 100 refers to the document numbers stored in the elements of the linked list, in sequence, from the starting element toward the ending element of the linked list (Step S203). The advertising apparatus 100 then advances the document number to be referred to in the postings list that includes the document number to which the advertising apparatus 100 has referred until the document number to be referred to is equal to or greater than the document number as a match candidate. Specifically, the advertising apparatus 100 refers to document number “2” that is included in the postings list of term 3. Then in the postings list of term 3, the advertising apparatus 100 advances the document number to be referred to from “2” to “5”.

When the document number to be referred to exceeds the document number as a match candidate in the postings list, the advertising apparatus 100 stores the document number that has exceeded the document number as a match candidate in the prioritized queue. Specifically, the advertising apparatus 100 stores document number 5 in the prioritized queue, as moved from the linked list.

The number of elements in the linked list falling short of the minimum requirement count set for the document number as a match candidate indicates that the count of the document number as a match candidate included in the linked list does not satisfy the minimum requirement count set for the document number as a match candidate. Specifically, document number 4 is not likely to match the query.

Upon finding that the count of the document number as a match candidate does not satisfy the minimum requirement count set for the document number as a match candidate, the advertising apparatus 100 skips the process for advancing the document number to be referred to until the document number to be referred to is equal to or greater than the document number as a match candidate. Specifically, the advertising apparatus 100 skips the process for advancing the document number to be referred to from 1 to 5 in the postings list of term 7.

The advertising apparatus 100 next stores the document number as another match candidate in the linked list, as moved from the prioritized queue (Step S204). When the number of elements in the linked list falls short of the minimum requirement count set for the document number as the other match candidate, the advertising apparatus 100 stores document numbers in the linked list as moved from the prioritized queue until the number of elements in the linked list is the minimum requirement count set for the document number stored in the starting element of the linked list, as at Step S202. Specifically, the advertising apparatus 100 stores document number 5 included in the postings list of term 2 in the linked list, as moved from the prioritized queue. It is noted that the starting element of the linked list is document number 5, so that the document number as the match candidate is “5”.

When a document number to be stored in the linked list next by the advertising apparatus 100, as moved from the prioritized queue, is identical to the starting document number in the linked list, the advertising apparatus 100 adds this document number to the starting element of the linked list. Specifically, the advertising apparatus 100 first stores document number 5 included in the postings list of term 2 in the linked list, as moved from the prioritized queue, and then adds document number 5 included in the postings list of term 3 to the elements of the linked list, as moved from the prioritized queue. It should be noted that, in the following, the expression of “the document number to be stored next in the linked list by the advertising apparatus 100, as moved from the prioritized queue” may be expressed as “the starting document number in the prioritized queue”.

Then, as at Step S203, the advertising apparatus 100 refers to the document numbers stored in the elements of the linked list, in sequence, from the starting element toward the ending element of the linked list (Step S205). Specifically, the advertising apparatus 100 first refers to document number 4 included in the postings list of term 1. In the postings list of term 1, the advertising apparatus 100 advances the document number to be referred to from “4” to “6”. This advancement results in the document number to be referred to exceeding the document number as a match candidate in the postings list of term 1, so that the advertising apparatus 100 stores document number 6 in the prioritized queue, as moved from the linked list. The advertising apparatus 100 further refers to document number 1 included in the postings list of term 7. In the postings list of term 7, the advertising apparatus 100 advances the document number to be referred to from “1” to “5”.

When the count of the document number as a match candidate in the elements of the linked list satisfies the minimum requirement count set for the document number as a match candidate, the advertising apparatus 100 accurately evaluates the Boolean expression set for the document associated with the document number as a match candidate to thereby determine whether the query actually matches the document (Step S206). Specifically, the advertising apparatus 100 accurately evaluates the Boolean expression set for the document associated with document number 5 that satisfies the condition of the minimum requirement count.

The advertising apparatus 100, after having determined whether the query matches the document, advances the document number to be referred to the document number that follows the document number that has been evaluated in the postings lists that include the document numbers stored in the linked list. Specifically, the advertising apparatus 100 advances, in the postings lists of term 3, term 2, and term 7, the document number to be referred to from “5” to “6”, from “5” to “16”, and from “5” to “11”, respectively. The advertising apparatus 100 then stores all document numbers to be referred to in the prioritized queue. Specifically, the advertising apparatus 100 stores document number 6, document number 16, and document number 11 in the prioritized queue, as moved from the linked list.

As described above, the advertising apparatus 100 according to the embodiments searches documents using the two data structures of the linked list and the prioritized queue. Upon finding that the document number as a match candidate does not satisfy the condition of the minimum requirement count, the advertising apparatus 100 shifts to the search process for the next match candidate. This arrangement eliminates the need for wastefully performing the process for advancing the document number to be referred to, as needed in the known art described with reference to FIG. 3, thereby allowing search efficiency to be enhanced.

2. Configuration of Search Process System

The following describes, with reference to FIG. 5, a configuration of a search process system 1 that includes the advertising apparatus 100 corresponding to the search apparatus according to the embodiments. FIG. 5 is a diagram illustrating an exemplary configuration of the search process system 1 according to the embodiments. As illustrated in FIG. 5, the search process system 1 according to the embodiments includes the user terminal 10, an advertiser terminal 20, a web server 30, and the advertising apparatus 100. These various types of apparatuses are connected with each other via a network N (e.g., a communication network such as the Internet) so as to be capable of communicating in a wired or wireless manner. The number of various types of apparatuses constituting the search process system 1 is not limited to a particular value illustrated in FIG. 5. For example, the search process system 1 illustrated in FIG. 5 may include a plurality of user terminals 10, a plurality of advertiser terminals 20, and a plurality of web servers 30.

The user terminal 10 is an information processing apparatus. Examples of the information processing apparatus include, but are not limited to, a desktop personal computer (PC), a notebook PC, a tablet terminal, a portable telephone, and a personal digital assistant (PDA). For example, the user terminal 10 accesses the web server 30 thereby to acquire a web page provided by the web server 30 and to display the acquired web page on a display unit (e.g., liquid crystal display). In order to deliver an advertisement content item (e.g., the advertisement content item associated with the document which the advertising apparatus 100 has searched for) to be displayed in an advertisement space within the web page, the user terminal 10 transmits to the advertising apparatus 100 a query as a delivery request for the advertisement content item.

The advertiser terminal 20 is an information processing apparatus that is used by an advertiser who requests advertisement delivery from the advertising apparatus 100. The advertiser terminal 20 submits an advertisement content item to the advertising apparatus 100 in accordance with an operation performed by the advertiser. Additionally, the advertiser terminal 20 sets a conditional expression using a Boolean expression for the advertisement content item in order to deliver the advertisement content item to an appropriate delivery object.

It is noted that, instead of submitting the advertisement content item to the advertising apparatus 100 by way of the advertiser terminal 20, the advertiser may requests an agency to make such submission, for example. In this case, it is the agency that, for example, submits the advertisement content item to the advertising apparatus 100. In the following, the expression of the “advertiser” is a concept including agencies in addition to the advertisers. The expression of the “advertiser terminal” includes not only the advertiser terminals, but also agency apparatuses used by the agency.

The web server 30 is a server apparatus that, when accessed by the user terminal 10, provides various web pages that serve as advertisement pages for displaying advertisement content items extracted by the advertising apparatus 100. The web server 30 provides various web pages relating to, for example, a news site, a weather forecast site, a shopping site, a finance (stock price) site, a route search site, a map providing site, a travel site, a restaurant introduction site, and a web log.

It is noted that the web page delivered by the web server 30 includes an advertisement space for displaying advertisement content as described above. The web page including the advertisement space includes an advertisement acquisition command for acquiring an advertisement content item to be displayed in the advertisement space. For example, a URL of the advertising apparatus 100 is described as the advertisement acquisition command in, for example, a HyperText Markup Language (HTML) file that forms a web page. In this case, the user terminal 10 accesses the URL described in, for example, the HTML file to thereby receive delivery of the advertisement content item from the advertising apparatus 100.

The advertising apparatus 100 is a server apparatus that searches for and extracts an advertisement content item on the basis of the query transmitted from a user who requests advertisement delivery to thereby deliver the extracted advertisement content item to the web site provided by the web server 30.

When delivering an advertisement content item, the advertising apparatus 100 distinguishes one user terminal 10 from another to thereby specify a specific user terminal 10 to which the advertisement content item is to be delivered. Specifically, specific users can be identified through inclusion of user identification information in a cookie that is exchanged between a web browser of the user terminal 10 and the advertising apparatus 100. This method of identifying users is, however, illustrative only and not limiting. For example, a dedicated program is set in the user terminal 10 and the user identification information is transmitted from such a dedicated program to the advertising apparatus 100.

3. Configuration of Advertising Apparatus

The following describes, with reference to FIG. 6, a configuration of the advertising apparatus 100 according to the embodiments. FIG. 6 is a diagram illustrating an exemplary configuration of the advertising apparatus 100 according to the embodiments. As illustrated in FIG. 6, the advertising apparatus 100 includes a communicator 110, a storage 120, and a controller 130. It is noted that the advertising apparatus 100 may further include an input unit (e.g., a keyboard and a mouse) that receives various types of operations from, for example, an administrator who uses the advertising apparatus 100 and a display unit (e.g., a liquid crystal display) for displaying various types of information.

Communicator 110

The communicator 110 may be achieved by, for example, a network interface card (NIC). The communicator 110 is connected with the network N in a wired or wireless manner and transmits and receives information to and from the user terminal 10, the advertiser terminal 20, and the web server 30.

Storage 120

The storage 120 may be achieved by, for example, a semiconductor memory device such as a random access memory (RAM) and a flash memory or a storage device such as a hard disk and an optical disc. As illustrated in FIG. 6, the storage 120 includes the advertising information storage unit 121 and a user information storage unit 122.

Advertising Information Storage Unit 121

The advertising information storage unit 121 stores advertisement content information 121A that represents information on an advertisement content item submitted from the advertiser terminal 20. The advertising information storage unit 121 further stores inverted index 121B that represents an inverted index associated with the advertisement content information 121A.

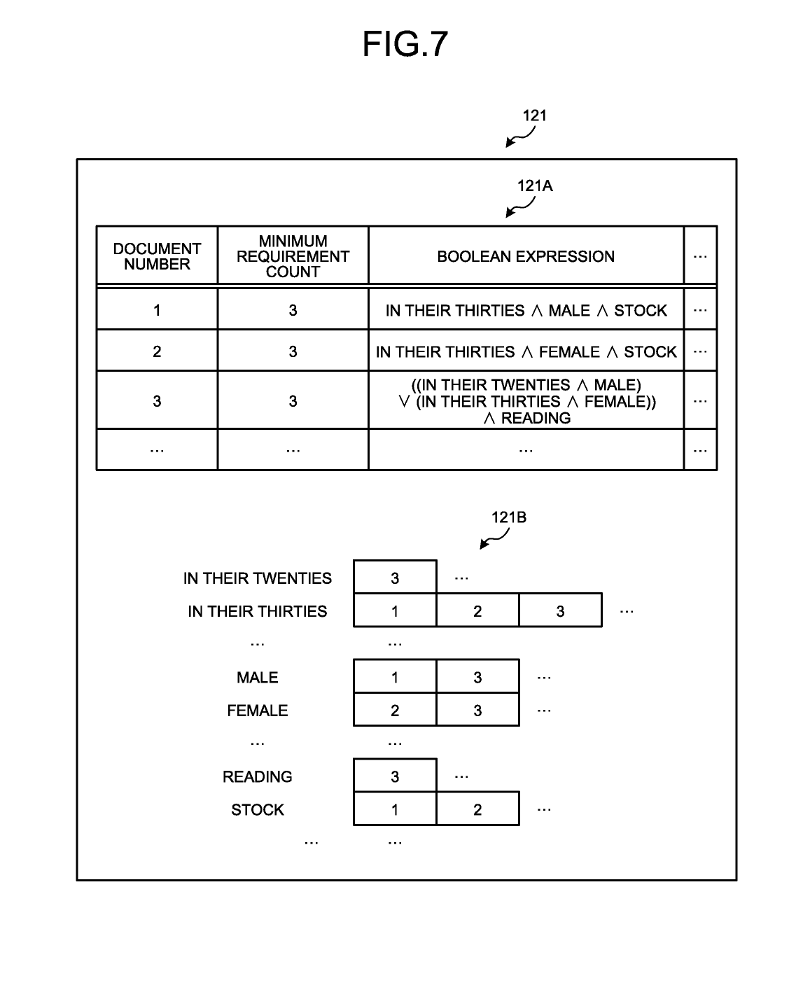

Reference is now made to FIG. 7 that illustrates an exemplary advertising information storage unit 121 according to the embodiments. FIG. 7 is a diagram illustrating the exemplary advertising information storage unit 121 according to the embodiments. In the example illustrated in FIG. 7, the advertisement content information 121A has such items as “document number”, “minimum requirement count”, and “Boolean expression”. The inverted index 121B is a data structure that, for each piece of “attribute information” (e.g., age bracket, sex, and hobby) included in the Boolean expression, arranges, in ascending order, the document numbers associated with respective documents that include the attribute information.

It is noted that advertisement content data actually delivered to the user terminal 10 may be stored in a predetermined advertisement delivery server that is provided separately from the advertising apparatus 100. In this case, the advertising apparatus 100 identifies an advertisement content item stored in the external advertisement delivery server using the document number stored in the advertising information storage unit 121. The advertising apparatus 100 then controls the advertisement delivery server such that the identified advertisement content item is delivered to the user terminal 10.

The “document number” indicates identification information for identifying a specific advertisement content item submitted from an advertiser to the advertising apparatus 100. The document number is assigned in advance to the advertisement content item such that the minimum requirement count increases with an increasing document number.

The “minimum requirement count” represents a minimum number of pieces of attribute information that is required to be included in a query in order for the query to match the Boolean expression set for the advertisement content item. The minimum requirement count set for the advertisement content item is determined by the Boolean expression set for each advertisement content item. For example, the Boolean expression set for an advertisement associated with document number “1” is “in their thirties [symbol] male [symbol] stock”. Thus, the three pieces of attribute information of “age bracket (in their thirties), “sex (male)”, and “hobby (stock)” are required in order for the query to match document number 1. Specifically, the minimum requirement count set for document number 1 is “3”.

The “Boolean expression” represents the Boolean expression set for each advertisement content item. The advertiser sets a Boolean expression upon submission of the advertisement content item. The advertiser thereby can select users to whom the advertisement content item is to be delivered and limit the delivery object so that the advertisement content item is delivered only to users who have a specific attribute.

It is noted that the inverted index 121B represents a collection of postings lists indicating the Boolean expression set for a specific advertisement content item in which each piece of the attribute information included in the Boolean expressions is included. For example, the postings list of “in their twenties” indicates that the attribute information of “in their twenties” is included in the Boolean expression set for the advertisement content item associated with document number 3.

Specifically, in FIG. 7, the advertisement content item identified by document number “1” has “3” set for the minimum requirement count set for the document and has “age bracket (in their thirties) [symbol] sex (male) [symbol] hobby (stock)” set as the Boolean expression.

User Information Storage Unit 122

The user information storage unit 122 stores information on users. Specifically, the user information storage unit 122 stores attribute information relating to users who requests advertisement content delivery from the advertising apparatus 100.

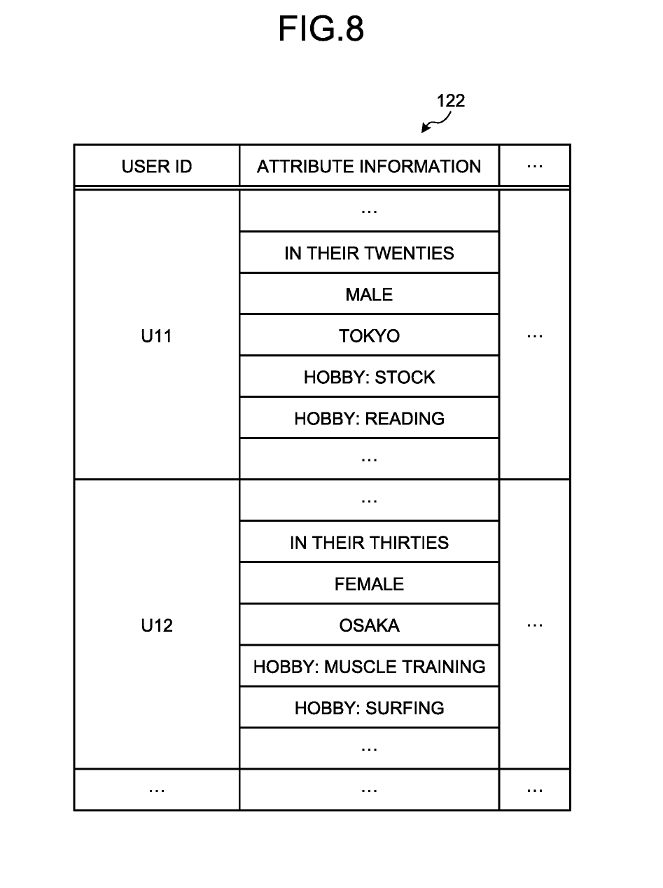

Reference is now made to FIG. 8 that illustrates an exemplary user information storage unit 122 according to the embodiments. FIG. 8 is a diagram illustrating the exemplary user information storage unit 122 according to the embodiments. In the example illustrated in FIG. 8, the user information storage unit 122 includes such items as “user ID” and “attribute information”.

The “user ID” is identification information that identifies the user terminal 10 and a user who operates the user terminal 10. In FIG. 8, the user ID is represented by “U11”. This representation indicates that the user terminal 10 is identified by user ID “U11” and that the user terminal 10 is operated by “user U11”.

The “attribute information” indicates attribute information of the user. The user attribute information includes information on, for example, sex, age bracket, and hobby of the user. Such attribute information may be used as terms included in the query.

Specifically, in FIG. 8, the user terminal 10 identified by user ID “U11” has attribute information of “in their twenties”, “male”, “Tokyo”, “hobby: stock”, and “hobby: reading”.

Additionally, the user information storage unit 122 may not have to be resident inside the advertising apparatus 100, but may, for example, be a predetermined log storage server connected with an outside. In this case, a delivery request reception unit 132 described later can acquire a log stored in the predetermined log storage server over the network N.

Controller 130

The controller 130 can be achieved by, for example, a central processing unit (CPU) or a micro-processing unit (MPU) executing various types of programs (that may correspond to, for example, an exemplary search program) stored in a storage device inside the advertising apparatus 100 using the RAM as a work space. Additionally, the controller 130 may be achieved by an integrated circuit, such as an application specific integrated circuit (ASIC) and a field programmable gate array (FPGA).

As illustrated in FIG. 6, the controller 130 includes a submission reception unit 131, the delivery request reception unit 132, a search unit 133, and a delivery unit 137. The controller 130 thereby achieves or performs information processing functions and operations described below. It is noted that the controller 130 may have an internal configuration that is not limited to the configuration illustrated in FIG. 6, but is required only to perform the information processing described later. The connection among different processing units included in the controller 130 is not limited to what is illustrated in FIG. 6, but may be any other.

Submission Reception Unit 131

The submission reception unit 131 receives submission of advertisement content from the advertiser terminal 20. When receiving the advertisement content, the submission reception unit 131 associates each of the advertisement content items with a corresponding Boolean expression set therefor. The submission reception unit 131 sets a document number that identifies the submitted advertisement content item and stores information on the submitted advertisement content item in the advertising information storage unit 121. In addition, the submission reception unit 131 prepares an inverted index that represents a collection of postings lists indicating the Boolean expression set for a specific advertisement content item in which each piece of the attribute information included in the Boolean expressions is included. The submission reception unit 131 then stores the prepared inverted index in the advertising information storage unit 121.

It is noted that the submission reception unit 131 does not necessarily require that the Boolean expression set for an advertisement content item be received simultaneously with the submission of the advertisement content item. Specifically, the submission reception unit 131 may receive the setting of the Boolean expression after the submission of the advertisement content item, or may receive a change in details of the Boolean expression after the reception of the setting of the Boolean expression.

Delivery Request Reception Unit 132

The delivery request reception unit 132 receives conditions for searching for advertisement content. Specifically, the delivery request reception unit 132 receives transmission source information that serves as conditions for searching for the advertisement content from a transmission source that requests delivery of the advertisement content (in this case, the user terminal 10). For example, the delivery request reception unit 132 receives a query as the transmission source information from the user terminal 10. The query is an advertisement content delivery request including information on the user as the transmission source of the delivery request, information retained by the user terminal 10, and information on the web page on which the delivered advertisement content is displayed. More specifically, the delivery request reception unit 132 receives as the query user attribute information, for example.

The delivery request reception unit 132 stores the received transmission source information in the user information storage unit 122. Instead of receiving from the user terminal 10 all information required for extraction of an advertisement content item as the query, the delivery request reception unit 132 may receive previously stored user information from the user information storage unit 122. When the query such as the above-described transmission source information is not received following the reception of the advertisement content delivery request, or when the received query fails to provide sufficient information for performing the search process, the advertising apparatus 100 may deliver an advertisement content item without performing the search process described below. In this case, the advertising apparatus 100 delivers an advertisement content item that can be delivered to unspecified users, not to specific targeted users.

Search Unit 133

The search unit 133 performs a predetermined search process for the advertisement content. Specifically, the search unit 133 extracts to store in the linked list starting document numbers in different postings lists until the minimum requirement count set for a maximum document number among the document numbers stored in the linked list is reached. When the maximum document number among the document numbers belonging to the linked list matches another document number included in the linked list, the search unit 133 retains the other document number in the linked list. When another document number does not match the maximum document number, the search unit 133 replaces the other document number with any other document number in the postings list to which the other document number belongs. The search unit 133 thereby searches for a predetermined document number such that the count of the predetermined document number in the linked list satisfies the minimum requirement count set for the predetermined document number. The search unit 133 includes an acquisition part 134, an extraction part 135, and a determination part 136 to thereby perform the above-described process.

Acquisition Part 134

The acquisition part 134 acquires for each condition a postings list that arranges document numbers, each being assigned to each advertisement content item and associated with an advertisement content item including a condition, in ascending order. Specifically, the acquisition part 134 refers to the inverted index 121B stored in the advertising information storage unit 121 and acquires the postings lists corresponding to the conditions received from the user terminal 10 or the conditions for searching for the advertisement content item. For example, the acquisition part 134 acquires from the inverted index 121B the postings lists corresponding to the user attribute information included in the query.

Extraction Part 135

The extraction part 135 extracts, using each of the postings lists acquired by the acquisition part 134, the document number such that the count of the document number satisfies the minimum requirement count set for the document number. Specifically, the extraction part 135 uses the two data structures of the linked list and the prioritized queue to extract the document number. The linked list and the prioritized queue serve as data structures for the extraction part 135 to store the document numbers to be referred to in the postings lists. The extraction part 135 temporarily stores data relating to the linked list and the prioritized queue in the storage 120 to thereby be able to refer to the document numbers stored in the linked list and the prioritized queue and the postings lists corresponding to the stored document numbers.

The extraction part 135 stores the document numbers in the elements of the linked list in descending order of the document numbers as viewed from the starting element of the linked list. The advertising apparatus 100 temporarily stores the document numbers in the prioritized queue. The extraction part 135 moves the document numbers from the elements of the prioritized queue to the elements of the linked list in ascending order of the document numbers.

As in the search process performed by the advertising apparatus 100 according to the embodiments described with reference to FIG. 4, the extraction part 135 combines “process 1”, “process 2”, and “process 3” described below to thereby achieve or perform an extraction process that extracts a document number associated with the advertisement content item satisfying the condition of the minimum requirement count.

“Process 1” in the extraction process initializes the prioritized queue. In “process 1”, the extraction part 135 refers to the starting document numbers in all postings lists in the collection of the postings lists acquired by the acquisition part 134 and stores in the prioritized queue all of the starting document numbers in the postings lists to which the extraction part 135 has referred.

“Process 2” in the extraction process selects document numbers as candidates for matching the query. In “process 2”, document numbers are moved from the elements of the prioritized queue to the elements of the linked list until the number of elements in the linked list is the minimum requirement count set for the document number stored in the starting element of the linked list. Additionally, in “process 2”, when the starting document number in the prioritized queue is identical to the starting document number in the linked list, the extraction part 135 adds the starting document number in the prioritized queue to the starting element of the linked list.

“Process 3” in the extraction process advances the document number to be referred to in postings list. “Process 3” refers to the document numbers stored in the elements of the linked list, in sequence, from the starting element toward the ending element of the linked list. “Process 3” then advances the document number to be referred to in the postings list that includes the document number to which “process 3” has referred until the document number to be referred to is equal to or greater than the document number as a match candidate. When the document number to be referred to exceeds the document number as a match candidate in the postings list, “process 3” stores the document number that has exceeded the document number as a match candidate in the prioritized queue. When the number of elements in the linked list falls short of the minimum requirement count set for the document number as a match candidate, “process 3” returns to “process 2”.

Determination Part 136

The determination part 136 performs a determination process that determines whether the advertisement content item associated with the document number extracted by the extraction part 135 matches the query. Specifically, the determination part 136 accurately evaluate the Boolean expression set for the extracted advertisement content item to thereby determine whether the query actually matches the advertisement content item. The determination part 136 extracts the advertisement content item that has been determined to match the query. After having determined whether the query matches the advertisement content item, the determination part 136 advances the document number to be referred to in the postings list that includes the document number stored in the linked list such that the document number to be referred to is next to the document number for which the determination process has been performed. The determination part 136 then stores all of the document numbers to be referred to in the prioritized queue.

Delivery Unit 137

The delivery unit 137 delivers the advertisement content item associated with the predetermined document number that has been searched for by the search unit 133 to the transmission source that has transmitted the conditions for searching for the advertisement content item. Specifically, the delivery unit 137 delivers the advertisement content item extracted by the determination part 136 to the user terminal 10 that has transmitted the query as the advertisement content delivery request acquired by the delivery request reception unit 132.

It is noted that the data of the advertisement content item actually delivered to the user terminal 10 may not have to be stored in the storage 120 of the advertising apparatus 100. For example, the delivery unit 137 may transmit an advertisement delivery control command to a predetermined advertisement delivery server provided externally, to thereby have the advertisement content item extracted by the determination part 136 delivered to the user terminal 10.

4. Search Process Steps

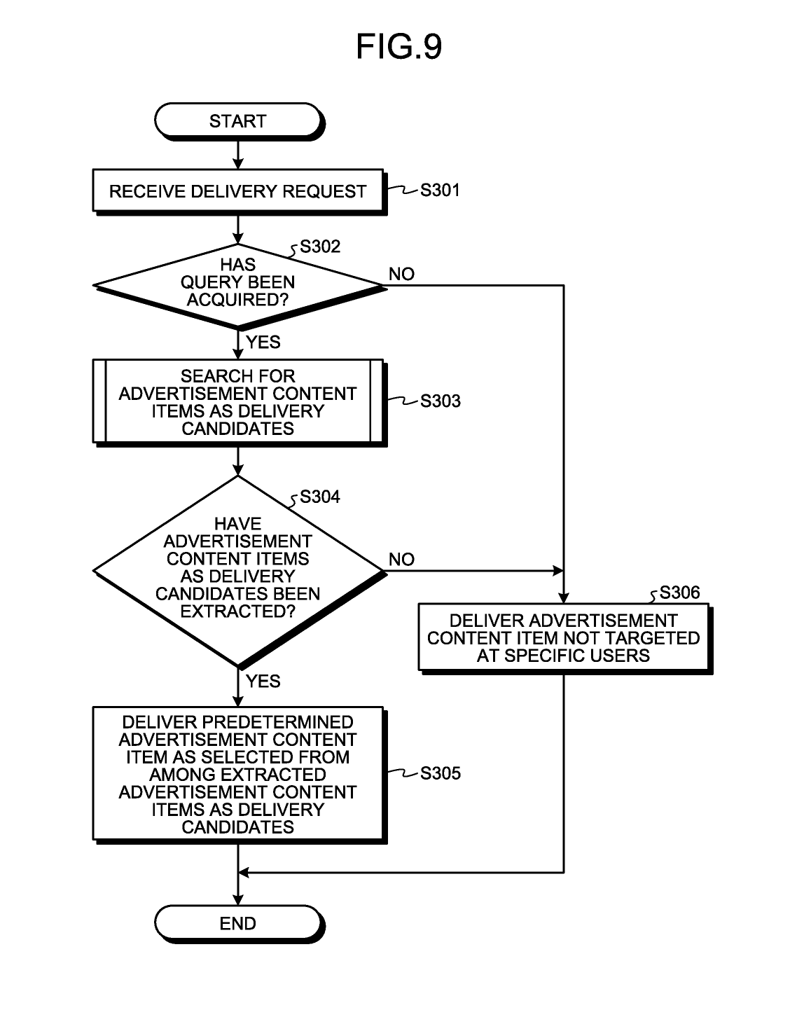

The following describes, with reference to FIG. 9, steps of the search process performed by the advertising apparatus 100 according to the embodiments. FIG. 9 is a flowchart illustrating the search process steps performed by the advertising apparatus 100 according to the embodiments.

As illustrated in FIG. 9, the delivery request reception unit 132 receives an advertisement content delivery request from the user terminal 10 (Step S301). The delivery request reception unit 132 determines whether a query that includes user attribute information is acquired together with the delivery request (Step S302). If it is determined that the query has been received (Yes at Step S302), the delivery request reception unit 132 transmits the received query to the search unit 133 to thereby cause the advertisement content search process to be started. The search unit 133 searches for advertisement content items as delivery candidates (Step S303).

If the search unit 133 has extracted at least one advertisement content item as the delivery candidates (Yes at Step S304), the delivery unit 137 selects a predetermined advertisement content item from among the extracted advertisement content items as the delivery candidates and delivers the selected predetermined advertisement content item to the user terminal 10 that has transmitted the query (Step S305).

If it is determined that the query including the user attribute information has not been received at Step S302 (No at Step S302), the delivery unit 137 delivers an advertisement content item that can be delivered to unspecified users so as not to be targeted at specific users (Step S306). It is noted that examples of cases in which the query is not received include, but are not limited to, a case in which all information relating to the query is not received and a case in which the process according to the embodiments is not achieved due to insufficient information despite the reception of part of the transmission source information.

If the search unit 133 has not extracted an advertisement content item as the delivery candidate at Step S304 (No at Step S304), the delivery unit 137 delivers an advertisement content item that can be delivered to unspecified users so as not to be targeted at specific users (Step S306). This step completes the search process by the advertising apparatus 100.

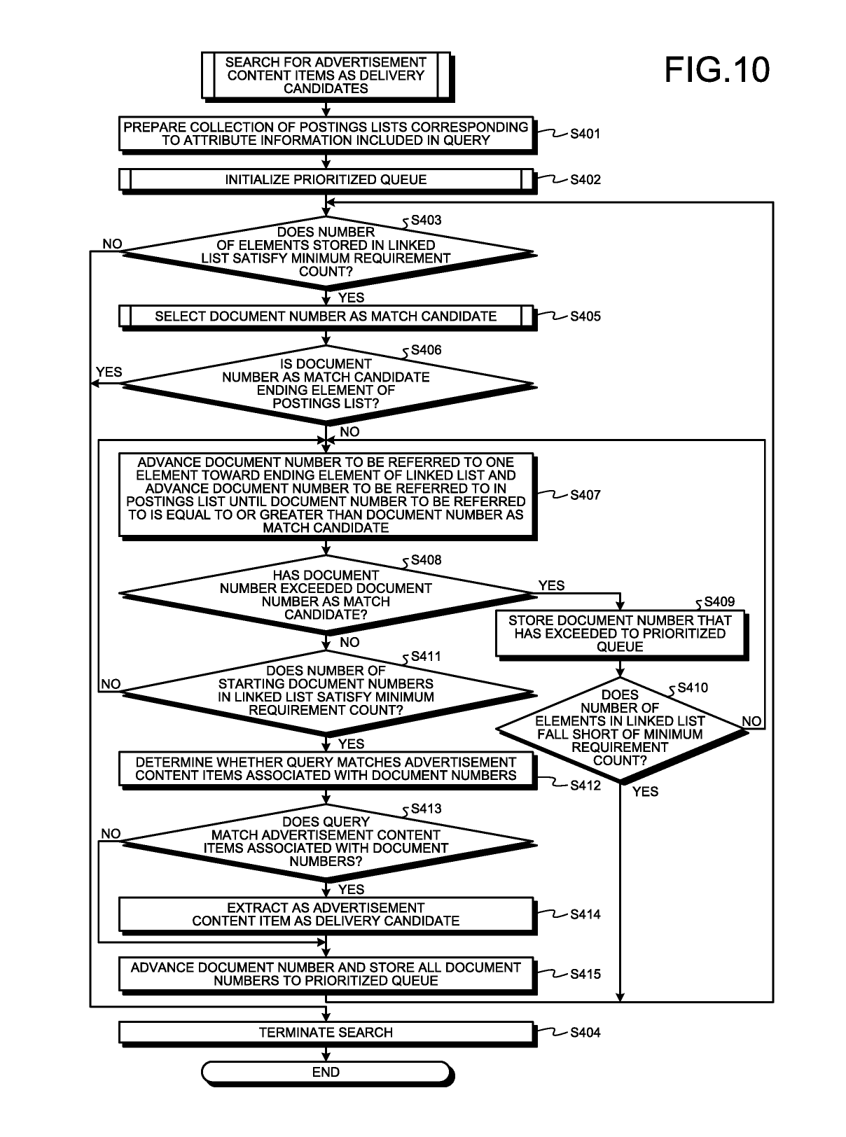

The following describes steps for searching for the advertisement content items as delivery candidates described at Step S303 in FIG. 9. The steps for searching for the advertisement content items as delivery candidates represent a process performed by the search unit 133 for searching for advertisement content items that match the query. FIG. 10 is a flowchart illustrating the process for searching for the advertisement content items as delivery candidates.

As illustrated in FIG. 10, the acquisition part 134 acquires a collection of postings lists corresponding to the attribute information included in the query from the information relating to the advertisement content stored in the advertising information storage unit 121 (Step S401). The extraction part 135 initializes the prioritized queue on the basis of the postings lists acquired by the acquisition part 134 (Step S402).

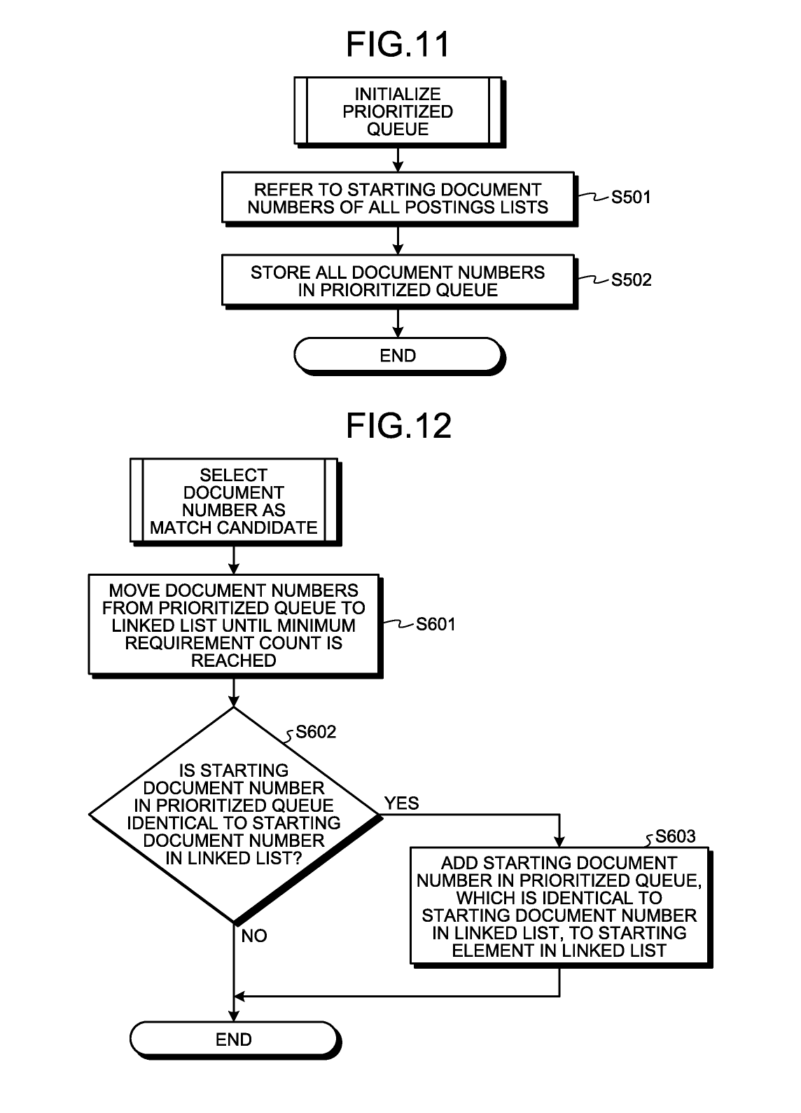

FIG. 11 is a flowchart illustrating a process for initializing the prioritized queue described at Step S402 in FIG. 10. The extraction part 135 refers to the starting document numbers of all postings lists in the collection of the postings lists acquired by the acquisition part 134 (Step S501). The extraction part 135 then stores in the prioritized queue all of the starting document numbers, to which the extraction part 135 has referred, of the postings lists (Step S502).

Reference is made back to FIG. 10. If the number of elements in the linked list falls short of the minimum requirement count set for the document number stored in the starting element in the linked list (No at Step S403), the extraction part 135 terminates the search of the advertisement content (Step S404). If the number of elements in the linked list satisfies the minimum requirement count set for the document number stored in the starting element in the linked list (Yes at Step S403), the extraction part 135 selects the document number as a match candidate (Step S405).

FIG. 12 is a flowchart illustrating a process for selecting the document number as a match candidate described at Step S405 in FIG. 10. The extraction part 135 moves document numbers from the elements in the prioritized queue to the elements in the linked list until the number of elements in the linked list is the minimum requirement count set for the document number stored in the starting element in the linked list (Step S601). It is here noted that the document number as a match candidate is the document number of the starting element in the linked list.

If the starting document number in the prioritized queue is not identical to the starting document number in the linked list (No at Step S602), the extraction part 135 terminates the process for selecting the document number as a match candidate. If the starting document number in the prioritized queue is determined at Step S602 to be identical to the starting document number in the linked list (Yes at Step S602), the extraction part 135 adds the starting document number in the prioritized queue to the starting element in the linked list (Step S603).

Reference is made back to FIG. 10. If, at Step S406, the document number as a match candidate is included in an ending element of all postings lists acquired by the acquisition part 134 (Yes at Step S406), the extraction part 135 terminates the search of the advertisement content (Step S404). If the document number as a match candidate is not included in an ending element of a postings list acquired by the acquisition part 134 (No at Step S406), the extraction part 135 advances the document number to be referred to one element down in the linked list from the starting element toward the ending element of the linked list (Step S407). Then, the extraction part 135 advances the document number to be referred to in the postings list that includes the document number to which the extraction part 135 has referred until the document number to be referred to is equal to or greater than the document number as a match candidate.

At Step S407, if the document number to be referred to in the postings list exceeds the document number as a match candidate (Yes at Step S408), the extraction part 135 stores the document number that has exceeded the document number as a match candidate in the prioritized queue (Step S409).

If the number of elements in the linked list falls short of the minimum requirement count set for the document number as a match candidate as a result of Step S409 (Yes at Step S410), the process proceeds to Step S403. If the number of elements in the linked list does not fall short of the minimum requirement count set for the document number as a match candidate as a result of Step S409 (No at Step S410), the process proceeds to Step S407. If, at Step S407, the document number to be referred to in the postings list does not exceed the document number as a match candidate (No at Step S408), the process proceeds to Step S411.

If the linked list is filled with elements that represent the document numbers as match candidates satisfying the minimum requirement count set for the document numbers as match candidates at Step S411 (Yes at Step S411), the determination part 136 determines whether the query matches the advertisement content item associated with the document number extracted by the extraction part 135 (Step S412). If the linked list is not filled with elements that represent the document numbers as match candidates satisfying the minimum requirement count set for the document numbers as match candidates at Step S411 (No at Step S411), the process proceeds to Step S407.

If, as a result of the determination made by the determination part 136, the query is determined to match the advertisement content item associated with the document number extracted by the extraction part 135 (Yes at Step S413), the determination part 136 extracts the extracted advertisement content item as the advertisement content item as a delivery candidate (Step S414). The determination part 136 then advances, in the postings list that includes the document number stored in the linked list, the document number to be referred to such that the document number to be referred to is next to the document number for which the determination has been made. The determination part 136 stores all document numbers to be referred to in the prioritized queue (Step S415). The search unit 133 goes to Step S403 and continues performing the search process. If, at Step S413, the query is determined not to match the advertisement content item associated with the document number extracted by the extraction part 135 (No at Step S413), the process proceeds to Step S415.

5. Modifications

The embodiments described above may be carried out in various types of embodiments other than the above-described ones. The following describes the other embodiments.

5-1. Initialization

As described with reference to Step S202 in FIG. 4, the embodiments described above have been exemplarily illustrated that the advertising apparatus 100 stores all of the starting document numbers to which the advertising apparatus 100 has referred in the postings lists. The advertising apparatus 100 may nonetheless store the starting document numbers of the postings lists until the number of elements in the linked list is the minimum requirement count set for the document number stored in the starting element of the linked list after the postings lists are sorted such that the starting document numbers of the postings lists are in ascending order as viewed from the start of the collection of postings lists. This approach enables the advertising apparatus 100 to start the search process without the need to initialize the prioritized queue at Step S202 in FIG. 4.

5-2. Linked List

As described with reference to FIG. 4, the embodiments described above have been exemplarily illustrated that the advertising apparatus 100 stores document numbers in the elements of the linked list in descending order of the document numbers as viewed from the starting element of the linked list. It is here noted that the advertising apparatus 100 may store the document numbers in the elements in the linked list only to ensure that the starting document number of the linked list is a maximum document number among the document numbers belonging to the linked list. For example, at Step S203 of FIG. 4, the advertising apparatus 100 may first refer to document number “1” included in the postings list of term 7 and, in the postings list of term 7, advance the document number to be referred to from “1” to “5”. This approach allows the advertising apparatus 100 to refer to the document numbers in order not limited to descending order of document numbers when referring to the document numbers stored in the elements in the linked list from the starting element toward ending element in the linked list.

A comparison may here be made between a case in which the document number to be referred to is advanced from “1” to “5” in the postings list of term 7 and a case in which the document number to be referred to is advanced from “2” to “5” in the postings list of term 3. Advancing the document number to be referred to from “2” to “5” first will make the search process speedier. More specifically, a probability that document number “5” is included in the elements after document number “2” in the postings list of term 3 is lower than a probability that document number “5” is included in the elements after document number “1” in the postings list of term 7. Thus, the advertising apparatus 100 can perform the search process at higher speed by storing the document numbers in the elements in the linked list in descending order of the document numbers as viewed from the starting element of the linked list and referring to the document numbers stored in the elements in the linked list, in sequence, from the starting element toward the ending element of the linked list.

5-3. Step to Return Document Number that has Exceeded to Prioritized Queue (1)

As described with reference to FIG. 4, the embodiments described above have been exemplarily illustrated that the advertising apparatus 100 stores the document number that has exceeded the document number as a match candidate in the prioritized queue. When the document number that has exceeded the document number as a match candidate is smaller than the starting document number in the prioritized queue, however, the advertising apparatus 100 may directly store the document number that has exceeded the document number as a match candidate in the starting element in the linked list.

5-4. Step to Return Document Number that has Exceeded to Prioritized Queue (2)

As described with reference to FIG. 4, in the embodiments, the advertising apparatus 100, after having determined whether the query matches the document, advances the document number to be referred to the document number that follows the document number that has been evaluated in the postings lists that include the document numbers stored in the linked list. The advertising apparatus 100 then stores all document numbers to be referred to in the prioritized queue. At this time, the advertising apparatus 100 may move the document numbers stored in the linked list to the prioritized queue until the number of elements in the linked list is lower than the minimum requirement count set for the starting document number (next match candidate) in the linked list.

5-5. Setting of Minimum Requirement Count

As described with reference to FIG. 1, the embodiments described above have been exemplarily illustrated that the minimum requirement count is set for each document on the basis of the Boolean expression set on the document side. Nonetheless, the minimum requirement count as a condition for the query to match the document may be set as a condition on the query side.

Assume, for example, that the advertising apparatus 100 has acquired a query that includes the conditions of “in their twenties [symbol] male [symbol] Tokyo [symbol] stock, minimum requirement count=2”. In this case, the condition of “minimum requirement count=2” indicates that, in order for the query to match a predetermined advertisement content item, the predetermined advertisement content item needs to include at least two pieces of attribute information among the attribute information pieces of “in their twenties”, “male”, “Tokyo”, and “stock”.

In this case, for example, an advertisement content item that includes attribute information of “in their twenties”, “male”, and “female” includes two pieces of attribute information included in the query. Thus, the query matches the advertisement content item that includes the attribute information of “in their twenties”, “male”, and “female”. An advertisement content item that includes attribute information of only “in their twenties” and “female”, however, includes only one piece of attribute information included in the query. Thus, the query does not match the advertisement content item that includes only the attribute information of “in their twenties” and “female”.

6. Hardware Configuration

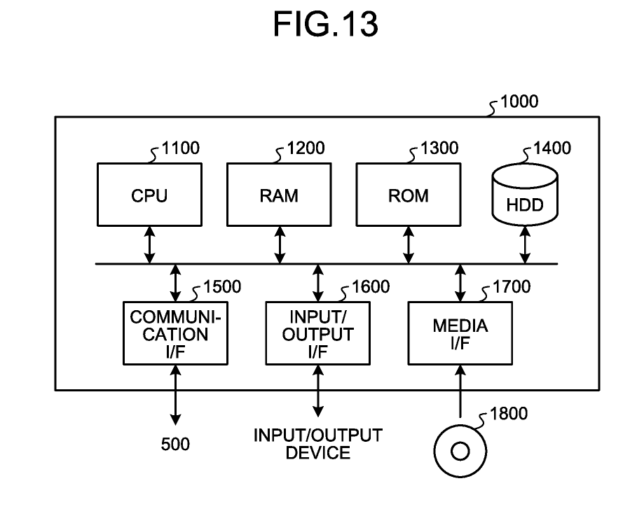

The advertising apparatus 100 according to the embodiments described above is achieved by a computer 1000 having a configuration as illustrated in FIG. 13. FIG. 13 is a hardware configuration diagram illustrating an exemplary computer 1000 that achieves functions of the advertising apparatus 100. The computer 1000 includes a CPU 1100, a RAM 1200, a ROM 1300, an HDD 1400, a communication interface (I/F) 1500, an input/output interface (I/F) 1600, and a media interface (I/F) 1700.

The CPU 1100 operates on a program stored in the ROM 1300 or the HDD 1400 to thereby control different elements. The ROM 1300 stores, for example, a boot program executed by the CPU 1100 during starting of the computer 1000 and a program dependent on hardware of the computer 1000.

The HDD 1400 stores, for example, a program executed by the CPU 1100 and data used by such a program. The communication I/F 1500 receives data from another device and transmits the data to the CPU 1100 via a communication network 500 (that corresponds to the network N illustrated in FIG. 5). The communication network 500 further transmits data generated by the CPU 1100 to the other device via the communication network 500.

The CPU 1100 controls an output device such as a display and a printer and an input device such as a keyboard and a mouse via the input/output I/F 1600. The CPU 1100 acquires data from the input device via the input/output I/F 1600. Additionally, the CPU 1100 outputs generated data to the output device via the input/output I/F 1600.

The media I/F 1700 reads a program or data stored in a recording medium 1800 and provides the CPU 1100 with the program or data via the RAM 1200. The CPU 1100 loads the program from the recording medium 1800 via the media I/F 1700 in the RAM 1200 and executes the loaded program. The recording medium 1800 may, for example, be an optical recording medium such as a digital versatile disc (DVD) and a phase change rewritable disk (PD), a magneto-optical recording medium such as a magneto-optical disk (MO), a tape medium, a magnetic recording medium, or a semiconductor memory.

When the computer 1000 functions as the advertising apparatus 100 according to the embodiments, for example, the CPU 1100 of the computer 1000 executes a program loaded on the RAM 1200 to achieve the functions of the controller 130. Additionally, the HDD 1400 stores data of the storage 120. The CPU 1100 of the computer 1000, while loading the program from the recording medium 1800 and executing the program, may alternatively acquire the program from another device via the communication network 500.

7. Miscellaneous

Of the processes described in the above embodiments, those processes that have been described to be performed automatically may be performed manually in whole or in part, or those processes that have been described to be performed manually may be performed, in whole or in part, automatically by a well-known method. Additionally, information given in the text and drawings of the present application, including the process steps, specific names, and various types of data and parameters may be changed as necessary unless otherwise specified. For example, various types of information illustrated in the drawings are illustrative only and not limiting.

The elements of different devices illustrated in the drawings are only functionally conceptual and are not necessarily required to be physically configured as illustrated. Specifically, specific configurations of distribution and integration of each device are illustrative only and not limiting and the devices can be functionally or physically distributed or integrated, in whole or in part, in any unit depending on, for example, load and use conditions. For example, the submission reception unit 131 and the delivery request reception unit 132 illustrated in FIG. 6 may be integrated with each other. Additionally, the information stored in the storage 120 may be stored in an externally provided storage via the network N.

The embodiments have been exemplarily illustrated that the advertising apparatus 100 performs the reception process for receiving submission of the advertisement content and queries, the search process for searching for the advertisement content to be delivered, and the delivery process for delivering the advertisement content. The advertising apparatus 100 described above may nonetheless be separated into a reception unit that performs reception, a search unit that performs a search process, and a delivery unit that performs a delivery process. In this case, the reception unit includes at least the submission reception unit 131 and the delivery request reception unit 132. The search unit includes at least the search unit 133. The delivery unit includes at least the delivery unit 137.

In addition, each of the embodiments described above can be combined with each other as appropriate such that process details are not contradictory to each other.

8. Effects

As described heretofore, the advertising apparatus 100 according to the embodiments includes the delivery request reception unit 132, the search unit 133, and the acquisition part 134. The delivery request reception unit 132 receives requirements for searching documents. The acquisition part 134 acquires, for each of the requirements, a first list (e.g., postings list) that represents a list including the requirement and arranging in ascending order, the document numbers being assigned to and associated with respective documents. The search unit 133 extracts starting document numbers of the respective requirements of the first list for each requirement acquired by the acquisition part to thereby prepare a second list. Each starting document number totals a count that satisfies a minimum requirement count that represents at least the number of requirements required for the document to be searched for. When a maximum document number among the document numbers belonging to the second list matches another document number included in the second list, the search unit 133 retains the other document number in the second list. When another document number does not match the maximum document number, the search unit 133 replaces the other document number with any other document number in the first list to which the other document number belongs. The search unit 133 thereby searches for a predetermined document number having a count satisfying the minimum requirement count in the second list.

Thus, the advertising apparatus 100 according to the embodiments can efficiently search for a document that satisfies the condition of the minimum requirement count, so that search efficiency in searching for a document using the inverted index can be enhanced.

The search unit 133 extracts from a queue (e.g., prioritized queue) that stores each starting document number of the first list to thereby prepare the second list such that at least the count of the document number included in the second list satisfies the minimum requirement count, the second list listing the document numbers stored in the queue in ascending order. When a document number that matches a maximum document number among the document numbers belonging to the second list is stored in the queue after the extraction, the search unit 133 further extracts the maximum document number stored in the queue to store the maximum document number in the second list.

Thus, the advertising apparatus 100 according to the embodiments can efficiently search for a candidate for a document that satisfies the condition of the minimum requirement count, so that search efficiency in searching for a document using the inverted index can be enhanced.

When the other document number does not match the maximum document number among the document numbers belonging to the second list, the search unit 133 searches for the document numbers included in the first list to which the other document number belongs in sorted order. When a document number that matches the maximum document number is not retrieved, the search unit 133 replaces a first element in the first list to which the other document number belongs with a minimum document number that is included in the first list to which the other document number belongs and that exceeds the maximum document number to thereby return the minimum document number to the queue. When a document number that matches the maximum document number is retrieved, the search unit 133 replaces a document number that is included in the first list and that matches the maximum document number with the other document number to thereby retain the other document number in the second list.

Thus, the advertising apparatus 100 according to the embodiments can skip searching documents that are not likely to satisfy the condition of the minimum requirement count, so that search efficiency in searching for a document using the inverted index can be enhanced.

When the count of the document number included in the second list does not satisfy the minimum requirement count after the replaced starting document number in the first list has been returned to the queue, the search unit 133 moves document numbers stored in the queue to the second list in ascending order such that at least the count of the document number included in the second list satisfies the minimum requirement count.

Thus, the advertising apparatus 100 according to the embodiments can quickly start searching for another candidate for the document that satisfies the condition of the minimum requirement count after having skipped searching documents that are not likely to satisfy the condition of the minimum requirement count, so that search efficiency in searching for a document using the inverted index can be enhanced.

When the count of the document number that matches the maximum document number among the document numbers belonging to the second list satisfies the minimum requirement count, the search unit 133 extracts the maximum document number as the predetermined document number.

Thus, the advertising apparatus 100 according to the embodiments can efficiently search for a candidate for a document that satisfies the condition of the minimum requirement count, so that search efficiency in searching for a document using the inverted index can be enhanced.

The search unit 133 determines whether a requirement or a combination of requirements received by the delivery request reception unit 132 complies with a conditional expression set for a document that is associated with the extracted predetermined document number. After the determination, the search unit 133 replaces a starting element in each first list to which the predetermined document number belongs with a minimum document number that exceeds the predetermined document number to thereby return the minimum document number to the queue.

Thus, the advertising apparatus 100 according to the embodiments can efficiently search for a candidate for a document that satisfies the condition of the minimum requirement count, so that search efficiency in searching for a document using the inverted index can be enhanced.

When a document number other than the predetermined document number is included in the second list after the determination, the search unit 133 replaces a starting element in the first list to which the document number other than the predetermined document number included in the second list belongs with a minimum document number that exceeds the predetermined document number to thereby return the minimum document number to the queue.

Thus, the advertising apparatus 100 according to the embodiments can efficiently search for a candidate for a document that satisfies the condition of the minimum requirement count, so that search efficiency in searching for a document using the inverted index can be enhanced.

The search unit 133, if unable to newly move a document number from the queue to the second list such that the count of the document number included in the second list satisfies the minimum requirement count set for a maximum document number among the document numbers belonging to the second list or the minimum requirement count set in the requirement received by the delivery request reception unit 132, terminates a process for searching for the predetermined document number.

Thus, the advertising apparatus 100 according to the embodiments can stop searching documents that are not likely to satisfy the condition of the minimum requirement count, so that search efficiency in searching for a document using the inverted index can be enhanced.

Additionally, the advertising apparatus 100 according to the embodiments further includes the delivery unit 137. The search unit 133 searches for, as the document associated with the predetermined document number, an advertisement content item for which requirements for retrieval have been set. The delivery unit 137 delivers a document associated with the predetermined document number retrieved by the search unit 133 to a transmission source that has transmitted requirements for searching for the document.

Thus, the advertising apparatus 100 according to the embodiments can efficiently search for an advertisement content item that satisfies the condition of the minimum requirement count, so that search efficiency in searching for an advertisement content item using the inverted index can be enhanced. As a result, the advertising apparatus 100 according to the embodiments can reduce time required for searching for advertisement content for delivering a specific advertisement content item to the transmission source.

It is noted that the “units” and “parts” mentioned above can be read as “means” or “circuits” as appropriate. For example, the acquisition part may be read as acquisition means or an acquisition circuit.

In one embodiment, the present invention can achieve an effect that search efficiency can be enhanced when searching documents using the inverted index.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A search apparatus comprising:
a reception unit that receives requirements for searching documents;
an acquisition part that acquires, for each of the requirements, a first list including the requirement, the first list arranging document numbers in ascending order, the document numbers being assigned to and associated with respective documents; and
a search unit that extracts starting document numbers of the respective requirements of the first list acquired by the acquisition part to prepare a second list, the starting document numbers each totaling a count that satisfies a minimum requirement count that represents at least a minimum number of requirements required as a condition for the document to be searched, that retains, when a maximum document number among the document numbers belonging to the second list matches another document number included in the second list, the other document number in the second list, and that replaces, when another document number does not match the maximum document number, the other document number with any other document number in the first list to which the other document number belongs, to search for a predetermined document number such that the count of the predetermined document number in the second list satisfies the minimum requirement count.

2. The search apparatus according to claim 1, wherein
the search unit extracts from a queue that stores each starting document number of the first list to prepare the second list such that at least the count of the document number included in the second list satisfies the minimum requirement count, the second list listing the document numbers stored in the queue in ascending order, and
when a document number that matches a maximum document number among the document numbers belonging to the second list is stored in the queue after the extraction, the search unit further extracts the maximum document number stored in the queue to store the maximum document number in the second list.

3. The search apparatus according to claim 2, wherein
when the other document number does not match the maximum document number among the document numbers belonging to the second list, the search unit searches the document numbers included in the first list to which the other document number belongs in sorted order, and
when a document number that matches the maximum document number is not retrieved, the search unit replaces a first element in the first list to which the other document number belongs with a minimum document number that is included in the first list to which the other document number belongs and that exceeds the maximum document number to return the minimum document number to the queue, and when a document number that matches the maximum document number is retrieved, the search unit replaces a document number that is included in the first list and that matches the maximum document number with the other document number to retain the other document number in the second list.

4. The search apparatus according to claim 3, wherein, when the count of the document number included in the second list does not satisfy the minimum requirement count after the replaced starting document number in the first list has been returned to the queue, the search unit moves document numbers stored in the queue to the second list in ascending order such that at least the count of the document number included in the second list satisfies the minimum requirement count.

5. The search apparatus according to claim 2, wherein, when the count of the document number that matches the maximum document number among the document numbers belonging to the second list satisfies the minimum requirement count, the search unit extracts the maximum document number as the predetermined document number.

6. The search apparatus according to claim 5, wherein
the search unit determines whether a requirement or a combination of requirements received by the reception unit complies with a conditional expression set for a document that is associated with the extracted predetermined document number, and
after the determination, the search unit replaces a starting element in each first list to which the predetermined document number belongs with a minimum document number that exceeds the predetermined document number to return the minimum document number to the queue.

7. The search apparatus according to claim 6, wherein, when a document number other than the predetermined document number is included in the second list after the determination, the search unit replaces a starting element in the first list to which the document number other than the predetermined document number included in the second list belongs with a minimum document number that exceeds the predetermined document number to return the minimum document number to the queue.

8. The search apparatus according to claim 2, wherein the search unit, upon being unable to newly move a document number from the queue to the second list such that the count of the document number included in the second list satisfies the minimum requirement count set for a maximum document number among the document numbers belonging to the second list or the minimum requirement count set in the requirement received by the reception unit, terminates a process for searching for the predetermined document number.

9. The search apparatus according to claim 1, further comprising:
a delivery unit that delivers a document associated with the predetermined document number retrieved by the search unit to a transmission source that has transmitted requirements for searching for the documents, wherein
the search unit searches for, as the document associated with the predetermined document number, an advertisement content item for which requirements for retrieval have been set, and
the delivery unit delivers the advertisement content item retrieved by the search unit to the transmission source.

10. A search method that causes a computer to execute, the search method comprising:
receiving requirements for searching documents;
acquiring, for each of the requirements, a first list including the requirements, the first list arranging document numbers in ascending order, the document numbers being assigned to and associated with respective documents; and
extracting starting document numbers of the respective requirements of the first list acquired at the acquiring to prepare a second list, the starting document numbers each totaling a count that satisfies a minimum requirement count that represents at least a minimum number of requirements required as a condition for the document to be searched, retaining, when a maximum document number among the document numbers belonging to the second list matches another document number included in the second list, the other document number in the second list, and replacing, when another document number does not match the maximum document number, the other document number with any other document number in the first list to which the other document number belongs, to search for a predetermined document number such that the count of the predetermined document number in the second list satisfies the minimum requirement count.

11. A non-transitory computer readable storage medium having stored therein a search program that causes a computer to execute:
receiving requirements for searching documents;
acquiring, for each of the requirements, a first list including the requirements, the first list arranging document numbers in ascending order, the document numbers being assigned to and associated with respective documents; and
extracting starting document numbers of the respective requirements of the first list acquired at the acquiring to prepare a second list, the starting document numbers each totaling a count that satisfies a minimum requirement count that represents at least a minimum number of requirements required as a condition for the document to be searched, retaining, when a maximum document number among the document numbers belonging to the second list matches another document number included in the second list, the other document number in the second list, and replacing, when another document number does not match the maximum document number, the other document number with any other document number in the first list to which the other document number belongs, to search for a predetermined document number such that the count of the predetermined document number in the second list satisfies the minimum requirement count.
